(19) United States
(12) Patent Application Publication
(10) Pub. No.: US 2010/0136296 A1
(43) Pub. Date: Jun. 3, 2010

(54) Densification of coating using laser peening

(75) Inventors: Kevin L. Collins, Mansfield, TX (US); Michael Minor, Arlington, TX (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: United Technologies Corporation

(21) Appl. No.: 11/606,832

(22) Filed: Nov. 30, 2006

(51) Int. Cl. B32B 1/00; B05D 3/06

(52) U.S. Cl. 428/174; 427/554

(57) ABSTRACT

A method of treating a coating includes the steps of providing the coating on a substrate and laser peening the coating. The laser peening consolidates the coating to reduce porosity and permits uniform consolidation in corners and tight spaces on articles such as gas turbine engine components.

### BACKGROUND OF THE INVENTION

This invention relates to coatings and, more particularly, to consolidating coatings to reduce porosity.

Coatings are widely known and used across a variety of fields for numerous different purposes. For example, one or more coatings are often used to impart a particular property or protect an underlying section from abrasion, high temperatures, or other environmental factors. Typically, the coating is deposited onto the substrate in a known manner. However, after deposition, the coating may include pores that compromise the coating and expose the substrate to a surrounding environment.

One solution to exposure from the pores is to consolidate, or densify, the coating to close the pores. For example, the coating is shot peened using media such as steel or ceramic particles. The particles impact and compress the coating to close the pores. Although effective, it is rather difficult to uniformly consolidate the coating using the media, particularly near corners or other geometric features. Due to a relatively close proximity and geometry of surfaces forming a corner, the media deflects into the path of the shot peening and interferes with consolidation in the corner. Thus, portions near the corner may remain unconsolidated.

Therefore, what is a needed is a method that permits uniform consolidation in tight areas to produce articles with uniformly consolidated coatings. This invention addresses these needs while avoiding the shortcomings and drawbacks of the prior art.

### SUMMARY OF THE INVENTION

An example method of treating a coating includes the steps of providing the coating on a substrate and laser peening the coating to consolidate it. Consolidation of the coating reduces the porosity. In one example, the power of a laser used to peen the coating is controlled to consolidate the coating to a desired degree, but is not too powerful to dislodge the coating from the substrate.

One example article, such as a gas turbine engine component, includes a substrate and a laser peened coating on the substrate. Laser peening to produce a laser peened coating permits uniform coating consolidation near corners, on curved surfaces, and in other tight spaces.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates selected portions of an example substrate and coating.

FIG. 2 illustrates the coating just before laser peening consolidation.

FIG. 3 illustrates the coating during laser peening.

FIG. 4 illustrates the coating after laser peening.

FIG. 5 illustrates an example gas turbine engine component having a laser peened coating.

### DETAILED DESCRIPTION OF THE PREFERRED EMBODIMENT

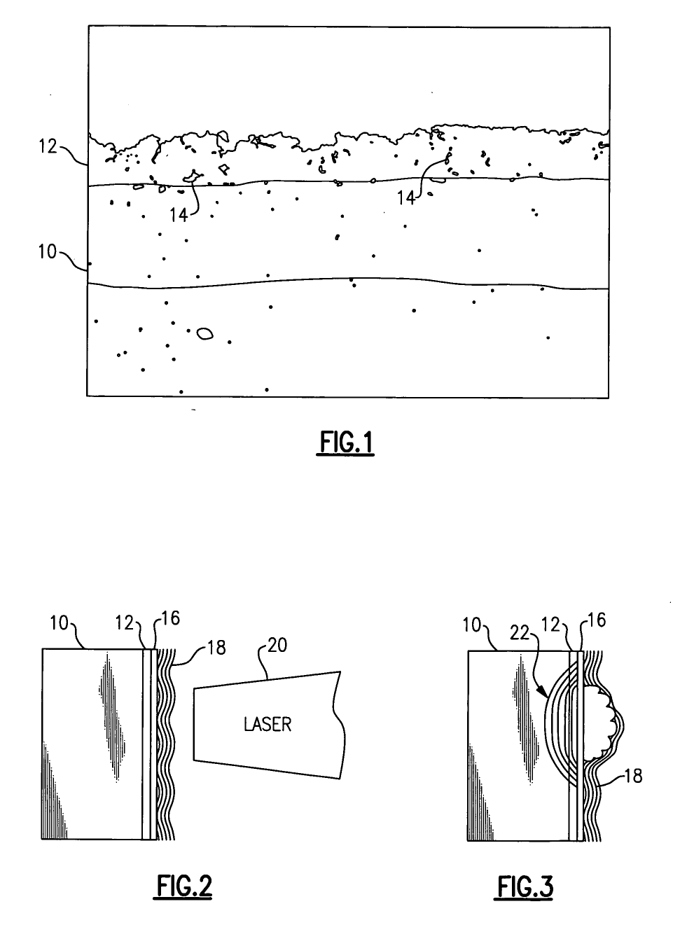

FIG. 1 schematically illustrates selected portions of an example substrate 10 and coating 12. In the illustration, the coating 12 is unconsolidated and includes pores 14 that are generally undesirable. For example, the pores 14 may expose the underlying substrate 10 to the surrounding environment or contribute to delamination of the coating 12. As will be described below, the coating 12 is consolidated using a laser peening method to close at least a portion of the pores 14.

Referring to FIG. 2, an ablative layer 16 is deposited on the coating 12. In one example, the ablative layer 16 is a known paint or tape material. In the disclosed example, a tamping layer 18 is disposed on the ablative layer 16 to at least partially contain the ablative layer 16 during laser peening, as will be described below.

In the disclosed example, a laser 20 is directed through the tamping layer 18 and impinges on the ablative layer 16. The laser 20 vaporizes the ablative layer 16, thereby causing a localized high pressure wave.

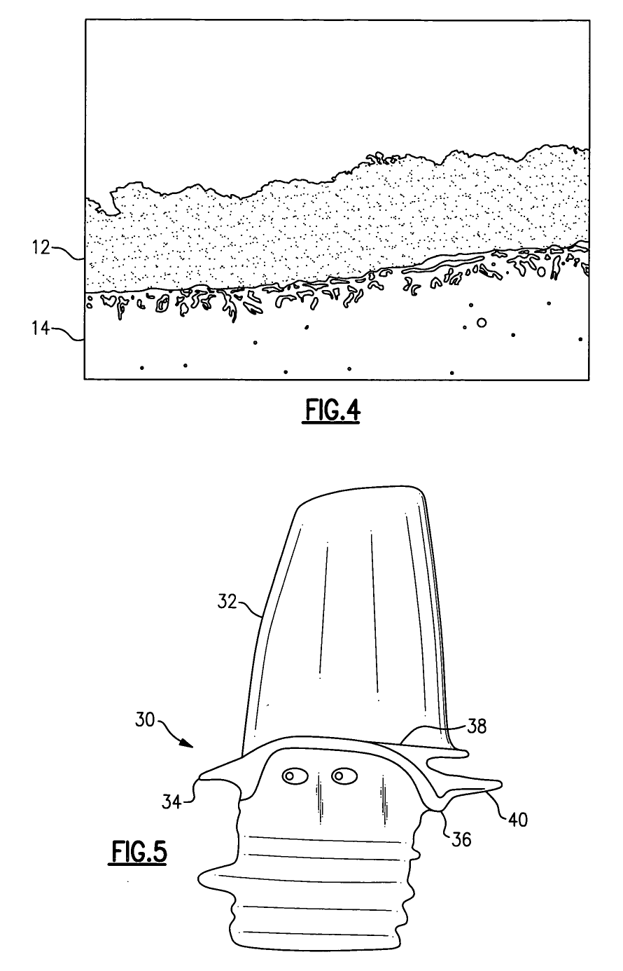

Referring to FIG. 3, the tamping layer 18 at least partially directs the high pressure wave 22 toward the coating 12 to produce a force that compresses the coating 12. The compressive force consolidates the coating 12 thereby closing at least some of the pores 14.

In one example, the power of the laser 20 is controlled to a selected range. In one example, the selected range is between 2 gigawatts (GW) and 20 GW. Selecting a power at or near 20 GW produces a relatively larger force that consolidates the coating 12 to a corresponding larger degree. Selecting a power at or near 2 GW produces a force that consolidates the coating 12 to a corresponding lesser degree. Depending on the type of the coating 12 and bonding strength between the coating 12 and the substrate 10, selecting a power above about 20 GW may dislodge the coating 12 from the substrate 10. However, selecting a power less than about 2 GW may not provide enough force to consolidate the coating 12 to a desired degree. Given this description, one or ordinary skill in the art will be able to select a suitable power to consolidate the coating 12 to meet their particular needs.

FIG. 4 schematically illustrates an example of the coating 12 after laser peening (i.e. a laser peened coating). In this example, the coating 12 includes a reduced amount of porosity. For example, the porosity can be measured using known techniques, such as optical techniques. In some examples, the porosity is practically eliminated.

The types of materials of the substrate 10 and the coating 12 may vary, depending on the intended use. In one example, the substrate 10 is a metal or metal alloy, such as a Nickel superalloy. In another example, the coating 12 includes Nickel, Chromium, Cobalt, Aluminum, Yttrium, or combinations thereof. It is to be understood that the disclosed examples contemplate using laser peening consolidation for any type of coating 12 that would benefit from consolidation. The coating 12 is deposited onto the substrate 10 in a known manner, such as by low pressure plasma deposition, physical vapor deposition, arc deposition, spray, or other known deposition method.

Using laser peening as described above provides the benefits of enabling uniform consolidation of the coating 12. In one example, laser peening permits uniform consolidation near corners, curved surfaces, or other relatively tight areas where it was previously difficult to achieve uniform consolidation using peening media particles.

FIG. 5 illustrates a gas turbine engine component 30 that is one example article that would benefit from laser peening. In this example, the gas turbine component 30 is a turbine blade that includes an airfoil section 32 and a platform section 34. In one example, the gas turbine engine component 30 is manufactured from a superalloy and coated with coating 12, as described above. Laser peening is used to consolidate the coating 12 on areas of the gas turbine engine component 30, such as curved surface 36 of the platform section 34, a corner 38 between the airfoil section 32 and the platform section 34, or curved underside surface 40 of the platform section 34. Given this description, one of ordinary skill in the art will recognize other articles and coatings that would benefit from laser peening consolidation.

Additionally, using laser peening instead of media particles to consolidate the coating 12 eliminates a risk of contaminating the gas turbine engine component 30 with the media particles. For example, gas turbine engine components 30 typically include internal cooling passages that open to outside surfaces of the component 30. The passages must be plugged for conventional peening to prevent media particles from entering the passages. Gas turbine engine components 30 are typically scrapped if even a few media particles infiltrate into the passages. By using laser peening, the scrap rate can be reduced because of elimination of the media particles, in addition to reducing expenses associated with plugging the openings.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of treating a coating, comprising:
(a) providing a coating that is unconsolidated on a substrate; and
(b) laser peening the coating to consolidate the coating.

2. The method as recited in claim 1, wherein said step (b) further includes consolidating the coating from a first porosity to a second porosity that is less than the first porosity.

3. The method as recited in claim 1, wherein said step (b) further includes laser peening using a nominal laser energy between 2 GW and 20 GW.

4. The method as recited in claim 1, wherein said step (b) further includes laser peening using a nominal laser energy between 4 GW and 16 GW.

5. The method as recited in claim 1, wherein said step (b) further includes laser peening using a nominal laser energy between 8 GW and 16 GW.

6. The method as recited in claim 1, wherein said step (b) further includes depositing a layer on the coating.

7. The method as recited in claim 6, wherein said step (b) further includes at least partially vaporizing the layer to produce a force that consolidates the coating.

8. The method as recited in claim 1, wherein the substrate of said step (a) comprises a gas turbine engine component.

9. The method as recited in claim 1, wherein the coating of said step (a) comprises a constituent from the group comprising Nickel, Chromium, Cobalt, Aluminum, Yttrium, and combinations thereof.

10. The method as recited in claim 1, wherein said step (b) comprises laser peening the coating on a section of the substrate having a curved surface.

11. The method as recited in claim 1, wherein said step (b) comprises laser peening the coating on a section of the substrate having a corner.

12. An article comprising:
a substrate; and
a laser peened coating on the substrate.

13. The article as recited in claim 12, wherein the article comprises a gas turbine engine component.

14. The article as recited in claim 12, wherein the laser peened coating comprises a constituent from the group comprising Nickel, Chromium, Cobalt, Aluminum, Yttrium, and combinations thereof.

15. The article as recited in claim 1, wherein the substrate comprises a section having a curved surface, and the laser peened coating is on the curved surface.

16. The article as recited in claim 1, wherein the substrate comprises a section having a corner, and the laser peened coating is on the corner.
